(19) United States
(12) Patent Application Publication
(10) Pub. No.: US 2026/0244762 A1
(43) Pub. Date: Aug. 20, 2026

(54) INFORMATION PRESENTATION DEVICE, INFORMATION PRESENTATION METHOD, AND RECORDING MEDIUM

(71) Applicant: NEC Corporation, Tokyo (JP)

(72) Inventors: Shunichi KINOSHITA, Tokyo (JP); Hirofumi UEDA, Tokyo (JP); Norio YAMAGAKI, Tokyo (JP); Mamoru SAITA, Tokyo (JP)

(73) Assignee: NEC Corporation, Tokyo (JP)

(21) Appl. No.: 19/430,839

(22) Filed: Dec. 23, 2025

(30) Foreign Application Priority Data
Feb. 14, 2025 (JP) 2025-022135

(51) Int. Cl. G06F 21/57; G06F 21/55

(52) U.S. Cl. CPC G06F 21/577; G06F 21/554; G06F 2221/034

(57) ABSTRACT

Provided is an information presentation device including an acquisition unit that acquires document data regarding cybersecurity, an extraction unit that extracts a candidate for an entity related to the cybersecurity from the acquired document data, a search unit that searches for relevant information associated with the extracted candidate, a generation unit that generates an instruction to request identification of an entity related to security, which is included in the document data, by using the document data and the relevant information extracted for each candidate, and an output unit that outputs attack information including an entity output from a model in response to the instruction.

This application is based upon and claims the benefit of priority from Japanese patent application No. 2025-022135, filed on February 14, 2025, the disclosure of which is incorporated herein in its entirety by reference.

### TECHNICAL FIELD

The present disclosure relates to an information presentation device, an information presentation method, and a program.

### BACKGROUND ART

With the increasing importance of cybersecurity (also referred to as security), it is required to quickly detect an occurrence of an attack related to the security and take appropriate measures. For example, a report (also referred to as a document) regarding security includes entities related to security, such as a victim name, an attacker name, a campaign name, an exploited vulnerability, targeted software, an attack tool, and an attack technique. When an entity related to security can be extracted from such a report, it is possible to analyze an attack and prepare measures.

PTL 1 (WO 2022/176209 A1) discloses a search device that searches for a document describing information regarding an attack by using behavior of an attacker. The search device in PTL 1 extracts a natural sentence from a document describing information regarding an attack. In a case where a degree of similarity between a phrase included in an extracted natural sentence and a natural sentence representing behavior of an attacker is equal to or more than a predetermined threshold value, the search device in PTL 1 generates a label indicating that behavior of the attacker, which is given to the document, is included in the document. The search device in PTL 1 learns a model that outputs a degree of relevance related to behavior of an attacker to a document by using, as teacher data, the document to which a label indicating that the behavior of the attacker is included is given. The search device in PTL 1 outputs the degree of relevance related to the behavior of the attacker to the document as a search target by using the learned model, thereby searching for a document including the behavior of the attacker from the document as the search target with respect to the behavior of the attacker designated as a search query.

In the technique of PTL 1, a document including behavior of an attacker is searched for from a document as a search target by using the model. However, in the technique of PTL 1, it is not possible to extract an entity related to security from the searched document. For example, when a technique of machine learning or natural language processing is used, it is possible to extract an entity related to security from a document. However, in a case where the technique of machine learning or natural language processing is used, it is necessary to prepare a large amount of learning data in order to accurately extract an entity from a document.

An object of the present disclosure is to provide an information presentation device, an information presentation method, and a program capable of accurately presenting an entity included in a document regarding cybersecurity.

### SUMMARY

According to an aspect of the present disclosure, an information presentation device includes an acquisition unit that acquires document data regarding cybersecurity, an extraction unit that extracts a candidate for an entity related to the cybersecurity from the acquired document data, a search unit that searches for relevant information associated with the extracted candidate, a generation unit that generates an instruction to request identification of an entity related to security, which is included in the document data, by using the document data and the relevant information extracted for each candidate, and an output unit that outputs attack information including an entity output from a model in response to the instruction.

According to another aspect of the present disclosure, an information presentation method includes, by a computer, acquiring document data regarding cybersecurity, extracting a candidate for an entity related to the cybersecurity from the acquired document data, searching for relevant information associated with the extracted candidate, generating an instruction for identifying an entity related to security among candidates by using the document data and relevant information extracted for each candidate, and outputting attack information including an entity output from a model in response to the instruction.

According to still another aspect of the present disclosure, a program causes a computer to execute a process including acquiring document data regarding cybersecurity, extracting a candidate for an entity related to the cybersecurity from the acquired document data, searching for relevant information associated with the extracted candidate, generating an instruction for identifying an entity related to security among candidates by using the document data and relevant information extracted for each candidate, and outputting attack information including an entity output from a model in response to the instruction.

According to the present disclosure, it is possible to provide an information presentation device, an information presentation method, and a program capable of accurately presenting an entity included in a document regarding cybersecurity.

### BRIEF DESCRIPTION OF THE DRAWINGS

FIG. 1 is a block diagram illustrating an example of a configuration relating to an information presentation device in the present disclosure;

FIG. 2 is a block diagram illustrating an example of a configuration of the information presentation device in the present disclosure;

FIG. 3 is a conceptual diagram illustrating an example of a report regarding a security attack, which is acquired by the information presentation device in the present disclosure;

FIG. 4 is a table showing an example of knowledge searched for by the information presentation device in the present disclosure;

FIG. 5 is a conceptual diagram illustrating an example of a prompt generated by the information presentation device in the present disclosure;

FIG. 6 is a conceptual diagram illustrating an example of a prompt generated by the information presentation device in the present disclosure;

FIG. 7 is a conceptual diagram illustrating a display example of an entity output from the information presentation device in the present disclosure;

FIG. 8 is a flowchart illustrating an example of an operation of the information presentation device in the present disclosure;

FIG. 9 is a flowchart illustrating an example of an identifying process by the information presentation device in the present disclosure;

FIG. 10 is a conceptual diagram illustrating an example of a report regarding a security attack, which is acquired by an information presentation device in the present disclosure;

FIG. 11 is a table showing an example of knowledge searched for by the information presentation device in the present disclosure;

FIG. 12 is a conceptual diagram illustrating an example of a prompt generated by the information presentation device in the present disclosure;

FIG. 13 is a conceptual diagram illustrating an example of a prompt generated by the information presentation device in the present disclosure;

FIG. 14 is a conceptual diagram illustrating a display example of an entity output from the information presentation device in the present disclosure;

FIG. 15 is a block diagram illustrating an example of a configuration of an information presentation device in the present disclosure;

FIG. 16 is a conceptual diagram illustrating an example of a report regarding a security attack, which is acquired by the information presentation device in the present disclosure;

FIG. 17 is a table showing an example of knowledge searched for by the information presentation device in the present disclosure;

FIG. 18 is a conceptual diagram illustrating an example of a knowledge graph referred to by the information presentation device in the present disclosure;

FIG. 19 is a conceptual diagram illustrating an example of relevant information searched for by the information presentation device in the present disclosure;

FIG. 20 is a conceptual diagram illustrating an example of a prompt generated by the information presentation device in the present disclosure;

FIG. 21 is a conceptual diagram illustrating an example of a prompt generated by the information presentation device in the present disclosure;

FIG. 22 is a conceptual diagram illustrating a display example of an entity output from the information presentation device in the present disclosure;

FIG. 23 is a flowchart illustrating an example of an operation of the information presentation device in the present disclosure;

FIG. 24 is a flowchart illustrating an example of an identifying process by the information presentation device in the present disclosure;

FIG. 25 is a block diagram illustrating an example of a configuration of an information presentation device in the present disclosure;

FIG. 26 is a flowchart illustrating an example of an operation of the information presentation device in the present disclosure; and

FIG. 27 is a block diagram illustrating an example of a hardware configuration that executes processing in the present disclosure.

### EXAMPLE EMBODIMENT

Hereinafter, modes for carrying out the present disclosure will be described with reference to the drawings. In the present disclosure, the drawings used in description of each example embodiment are associated with one or more example embodiments. Elements included in each drawing may apply to one or more example embodiments. The example embodiments described below have technically preferable limitations for carrying out the present disclosure, but the scope of the disclosure is not limited to the following. In all the drawings used in the following description of the example embodiments, the same reference signs are given to similar parts unless otherwise specified. In the following example embodiments, repeated description of similar configurations and operations may sometimes be omitted. The directions of the arrows in the drawings indicate examples of flows of signals, data, and the like and do not limit the flows of signals, data, and the like.

### First Example Embodiment

First, an information presentation device according to a first example embodiment will be described with reference to the drawings. The information presentation device in the present example embodiment acquires a report (also referred to as a document) regarding a cybersecurity (also referred to as security) attack. The information presentation device in the present example embodiment extracts an entity related to security from the acquired report. The entity related to security refers to an element related to a cyber attack. For example, a report (document) regarding a security attack includes entities related to security, such as a victim name, an attacker name, a campaign name, an exploited vulnerability, targeted software, an attack tool, and an attack technique. The entity related to security is used for detailed analysis on a cyber attack and preparation of measures.

### Configuration

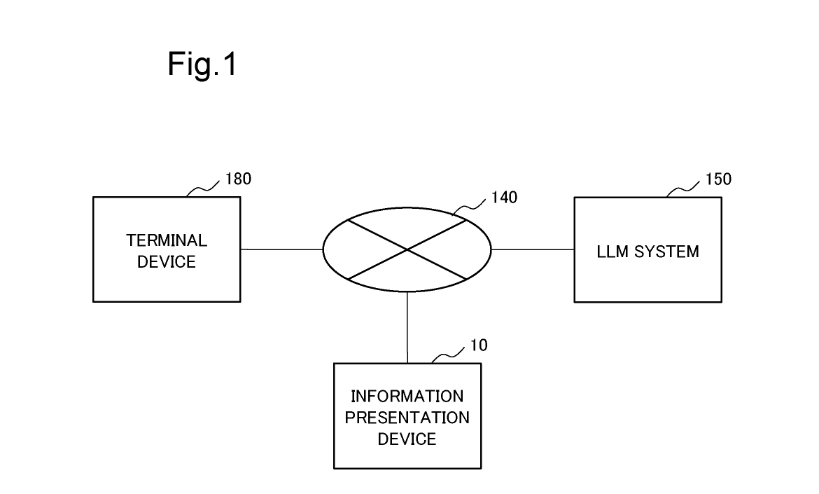

FIG. 1 is a block diagram illustrating an example of a configuration relating to the information presentation device according to the present disclosure. An information presentation device 10 is connected to a terminal device 180 and an LLM system 150 via a network 140 such as the Internet or an intranet. The information presentation device 10 is connected to an information source such as an external Website via the network 140.

The terminal device 180 is an information processing device (computer) used by a user who performs work related to cybersecurity. The terminal device 180 provides an interface for performing work related to security. Application software for executing processing related to security is installed on the terminal device 180. The terminal device 180 executes processing set by a user. For example, the terminal device 180 may be implemented in a cloud or a server. The function of the application software for executing processing related to security may be built in a server or a cloud accessible from the terminal device 180. The terminal device 180 may be achieved by a general-purpose computer. The terminal device 180 may be achieved by a dedicated computer for executing processing related to security.

The terminal device 180 acquires attack information (attack data) including an entity regarding security, which has been extracted from a report regarding a security attack, from the information presentation device 10. The terminal device 180 displays the entity included in the acquired attack information (attack data) on a screen of the terminal device 180.

The LLM system 150 is a system that executes processing using a large-scale language model (not illustrated). The large-scale language model (also referred to as a model) is a deep learning model trained using a large-scale language data set. The LLM system 150 outputs text information according to the contents of text information configured in a natural language by using the large-scale language model. The LLM system 150 may be a model capable of inputting and outputting images and sounds. For example, the LLM system 150 is a system available via an application programming interface (API). The LLM system 150 may be configured to use a dedicated model built to perform processing related to security. As long as an access from the information presentation device 10 is possible, no limitation is imposed on the type of the large- scale language model used by the LLM system 150 and a place where the LLM system 150 is disposed.

### Information Presentation Device

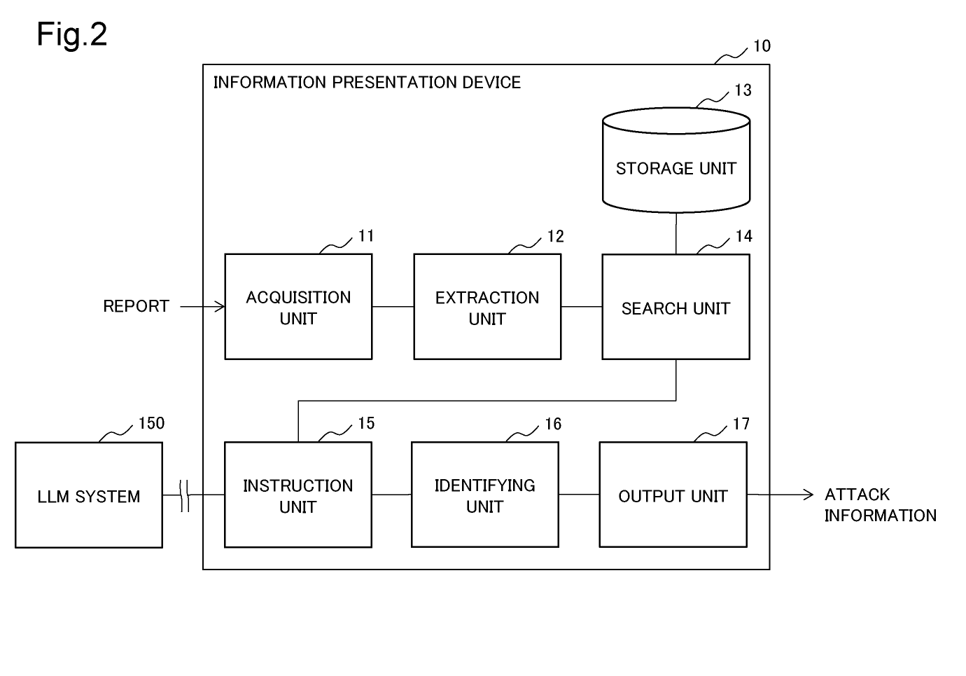

Next, an example of a configuration of the information presentation device 10 will be described with reference to the drawings. FIG. 2 is a block diagram illustrating the example of the configuration of the information presentation device in the present disclosure. The information presentation device 10 includes an acquisition unit 11, an extraction unit 12, a storage unit 13, a search unit 14, an instruction unit 15, an identifying unit 16, and an output unit 17. The instruction unit 15 is connected to the LLM system 150.

The acquisition unit 11 acquires a report (also referred to as document data) regarding a security attack from an external Website or the like. For example, the report is a document regarding security, such as news regarding security, a threat report, or a damage report. The report includes entities related to security. The report is not limited to news, a threat report, a damage report, or the like as long as the report includes information regarding a security attack.

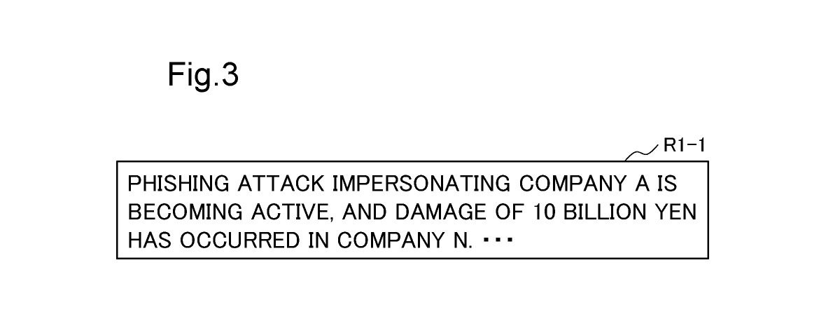

FIG. 3 is a conceptual diagram illustrating an example of the report regarding a security attack, which is acquired by the information presentation device in the present disclosure. A report R1-1 includes contents related to security, that “a phishing attack impersonating Company A is becoming active, and damage of 10 billion yen has occurred in Company N....”

The extraction unit 12 extracts an entity candidate related to security from the acquired report. For example, the entity as an extraction target relates to an attacker, an attack, a vulnerability, a victim, an attack target, and the like. For example, an entity related to an attacker includes the name of the attacker or the name of a campaign. For example, an entity related to an attack includes an attack technique and a name of malware. For example, an entity related to a vulnerability includes the name of the vulnerability. For example, an entity related to a victim includes the name of the victim, a damage amount, and a damage description. For example, an entity related to an attack target includes the name of the attacked software. The entity regarding security is not limited to the examples given here.

For example, the extraction unit 12 extracts a keyword matching a keyword or a regular expression included in a dictionary prepared in advance, as an entity candidate. For example, the extraction unit 12 is configured to extract an entity candidate by using named entity recognition (NER) using a learned model. For example, the extraction unit 12 is configured to extract a noun as an entity candidate by morphological analysis. For example, the extraction unit 12 may be configured to extract an entity candidate by using the LLM system 150 including a large-scale language model.

In the example of FIG. 3, entity candidates “Company A”, “phishing attack”, “Company N”, and “10 billion yen” are extracted from the report R1-1. “Phishing attack” corresponds to an attack technique name. “Company N” corresponds to the name of a victim. “10 billion yen” corresponds to a damage amount. The entity candidates “phishing attack”, “Company N”, and “10 billion yen” are relevant to entities related to security. On the other hand, “Company A” is a company name that has been abused as an attacker name, and is not relevant to the entity extracted from the report R1-1.

The storage unit 13 stores knowledge associated with a target related to security. The target related to security includes a victim name, a damage description, a damage amount, an attacker name, an attack technique name, an attack tool, an attack technique, malware, a campaign name, an exploited vulnerability, targeted software, and the like. These targets are relevant to entities. The knowledge associated with the target related to security is stored in the storage unit 13 in advance. In a case where the knowledge disclosed via a network is searched, the storage unit 13 may be omitted.

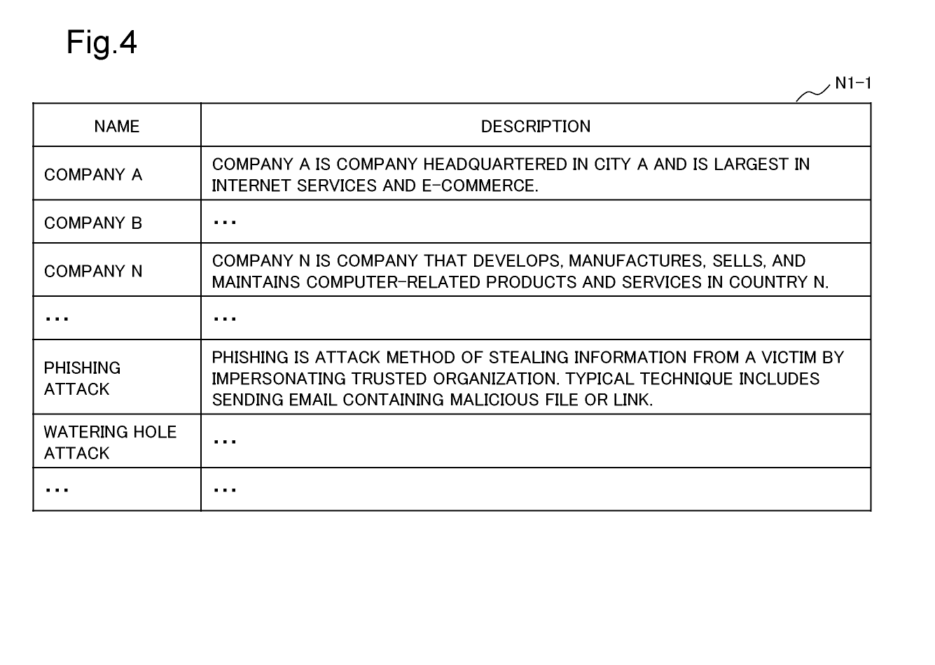

FIG. 4 is a table showing an example of knowledge searched for by the information presentation device in the present disclosure. A knowledge table N1-1 includes relevant information for each entity. The relevant information includes description (knowledge) regarding an entity. For example, with respect to “Company A”, knowledge that “Company A is a company headquartered in City A and is the largest in Internet services and e-commerce.” is associated. For example, with respect to “Company N”, knowledge that “Company N is a company that develops, manufactures, sells, and maintains computer-related products and services in Country N.” is associated. For example, with respect to “phishing attack”, knowledge that “phishing is an attack technique in which information is stolen from a victim by impersonating a trusted organization. A typical technique includes sending an email containing a malicious file or link.” is associated.

The search unit 14 searches the storage unit 13 for knowledge (relevant information) relevant to a value associated with an entity candidate extracted from the extraction unit 12, by using the entity candidate as a key. The search unit 14 may be configured to search for relevant information associated with an entity candidate extracted by the extraction unit 12, via a network. For example, the search unit 14 may be configured to extract disclosed knowledge by using a search engine available via a network.

The instruction unit 15 acquires a body (document data) of the acquired report. The instruction unit 15 acquires relevant information associated with an entity candidate extracted from the report. The instruction unit 15 generates a prompt (also referred to as an instruction) for identifying an entity related to security by using the relevant information associated with the entity candidate extracted from the report and the body of the report. A functional configuration of the instruction unit 15 for generating a prompt (instruction) is also referred to as a generation unit. The instruction unit 15 inputs the generated prompt into the LLM system 150. In the present example embodiment, the instruction unit 15 generates a first prompt and a second prompt. The instruction unit 15 may handle a title, an appendix, or a summary of the report as document data instead of the body of the acquired report. Alternatively, the instruction unit 15 may handle at least any combination of the body, the title, the appendix, and the summary of the report as the document data.

The instruction unit 15 generates a first prompt for inputting knowledge associated with the entity candidate to the LLM system 150. The first prompt includes knowledge for each entity candidate. The instruction unit 15 generates the first prompt by using a template set in advance. A template for generating the first prompt includes an instruction sentence that instructs to set knowledge associated with the entity candidate as a precondition. The instruction unit 15 inputs the generated first prompt into the LLM system 150.

The instruction unit 15 acquires text information output from the LLM system 150 in response to an input of the first prompt. The text information output from the LLM system 150 in response to the input of the first prompt is relevant to an answer to the first prompt. An answer to the first prompt triggers the information presentation device 10 to input a second prompt to the LLM system 150.

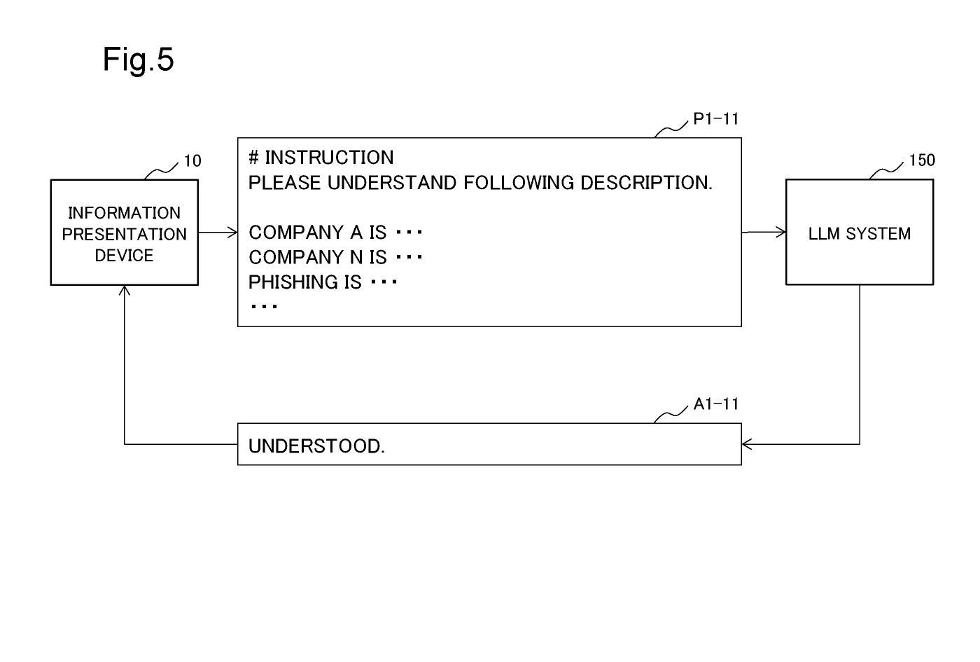

FIG. 5 is a conceptual diagram illustrating an example of the prompt generated by the information presentation device according to the present disclosure. FIG. 5 illustrates an example of a first prompt P1-11 generated by the information presentation device 10. The first prompt P1-11 includes an instruction sentence, and knowledge for each entity candidate. The instruction sentence includes text information indicating that “please understand the following description”. The knowledge for each entity candidate includes a description exemplified in the knowledge table N1-1 of FIG. 4. FIG. 5 illustrates an answer A1-11 output from the LLM system 150 in response to an input of the first prompt P1-11. The answer A1-11 includes text information indicating that the contents of the first prompt P1-11 are set as a precondition in the LLM system 150, that is, “understood”.

The instruction unit 15 also generates a second prompt to instruct the LLM system 150 to extract an entity from the body of the report. The second prompt includes an instruction to extract an entity from the body of the report. The second prompt may include an instruction to extract an entity from a title, an appendix, or a summary of the report, instead of the body of the report. The second prompt may include an instruction to extract an entity from at least any combination of the body, the title, the appendix, and the summary of the report. The instruction unit 15 generates the second prompt by using a template set in advance. The instruction unit 15 inputs the generated second prompt into the LLM system 150. The instruction unit 15 may be configured to generate a prompt in which the contents of the first prompt and the contents of the second prompt are unified. In that case, the prompt includes an instruction to set knowledge for each entity candidate as a precondition and an instruction to extract an entity from the body of the report.

For example, the instruction unit 15 is configured to generate a prompt including an instruction to collectively extract types of a plurality of entities. For example, the instruction unit 15 is configured to generate a prompt including an instruction to extract an entity for each type of the entity. For example, the instruction unit 15 may be configured to input a prompt including an instruction to extract “attacker name” to the LLM system 150, and then input a prompt including an instruction to extract “victim name” to the LLM system 150, for the same report. That is, the instruction unit 15 may be configured to input, to the LLM system 150, a prompt including an instruction to sequentially extract relevant information for each of a plurality of entities, for the same report. Also in the first prompt, in a case where there are a plurality of pieces of relevant information associated with an entity candidate, the plurality of pieces of relevant information may be input to the LLM system 150 in one prompt, or the plurality of pieces of relevant information may be sequentially input to the LLM system 150.

The instruction unit 15 acquires text information output from the LLM system 150 in response to an input of the second prompt. The text information output from the LLM system 150 in response to the input of the second prompt is relevant to an answer to the second prompt. The text information includes an entity extracted from the report.

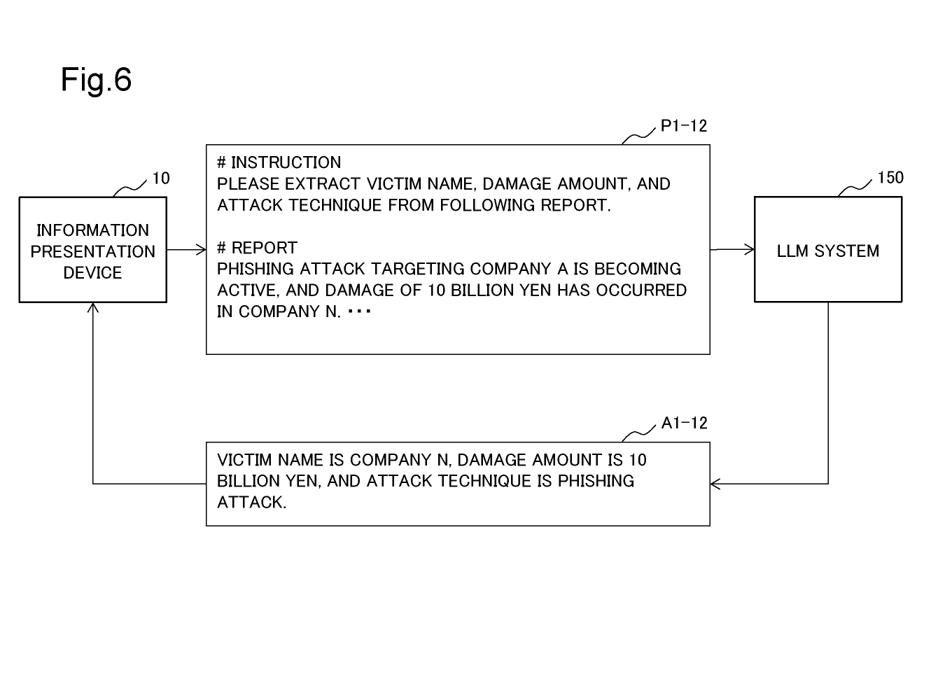

FIG. 6 is a conceptual diagram illustrating an example of the prompt generated by the information presentation device according to the present disclosure. FIG. 6 illustrates an example of a second prompt P1-12 generated by the information presentation device 10. The second prompt P1-12 includes an instruction sentence and the body of the report R1-1. The instruction sentence includes text information indicating that “please extract a victim name, a damage amount, and an attack technique from the following report”. The body of the report includes the body of the report R1-1 illustrated in FIG. 3. FIG. 6 illustrates an answer A1-12 output from the LLM system 150 in response to an input of the second prompt P1-12. The answer A1-12 includes text information indicating that “the victim name is Company N, the damage amount is 10 billion yen, and the attack technique is a phishing attack”. The answer A1-12 includes an entity extracted based on the relevant information input by the first prompt P1-11.

In the above description, the instruction unit 15 inputs information to the LLM system 150 by using the first prompt and the second prompt and acquires an entity included in the body of the report, and the present example embodiment is not limited to this. For example, the instruction unit 15 may input information to the LLM system 150 by using retrieval-augmented generation (RAG) or fine tuning instead of the first prompt in the above description. For example, the instruction unit 15 may generate a single prompt including both information included in the first prompt and information included in the second prompt. In that case, the instruction unit 15 inputs this single prompt to the LLM system 150, and acquires text information regarding an entity output from the LLM system 150.

The identifying unit 16 acquires text information including an entity extracted from the report. The identifying unit 16 identifies an entity included in the text information. A configuration in which the text information including the entity extracted from the report is output to the output unit 17 may be made. In that case, the identifying unit 16 may be omitted.

The output unit 17 is connected to the terminal device 180 used by the user. The output unit 17 acquires the identified entity. The output unit 17 outputs attack information (attack data) including the acquired entity to the terminal device 180. An entity included in the attack information output to the terminal device 180 is displayed on the screen of the terminal device 180. The output unit 17 may be configured to retain attack information including the entity in a database (not illustrated).

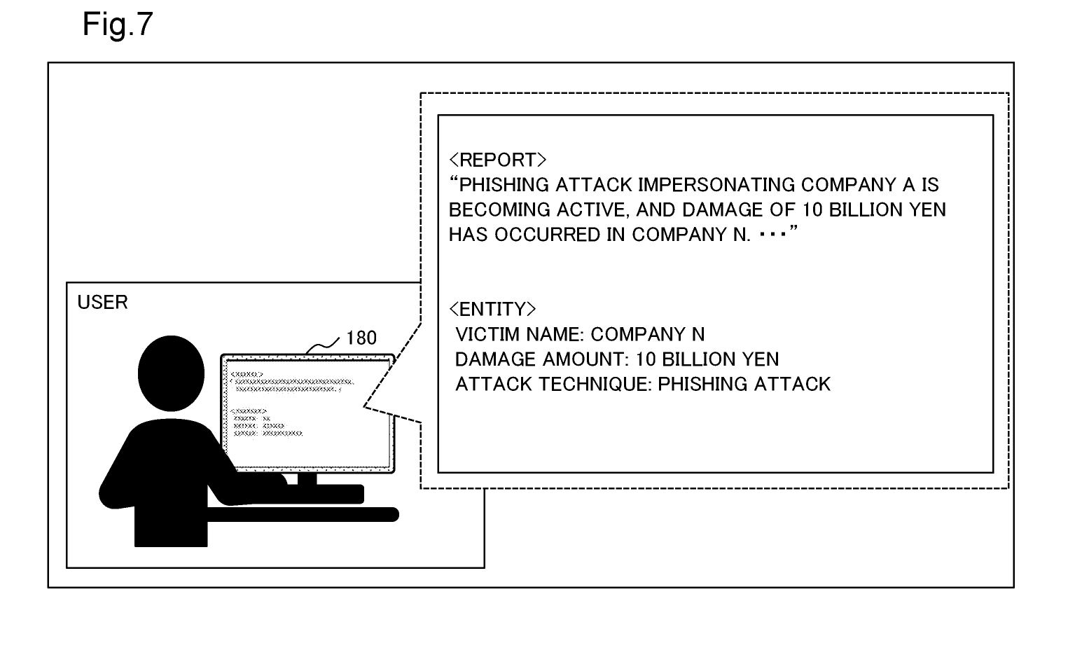

FIG. 7 is a conceptual diagram illustrating a display example of an entity output from the information presentation device in the present disclosure. Text information indicating a body of a report that “a phishing attack impersonating Company A is becoming active, and damage of 10 billion yen has occurred in Company N....” is displayed on the screen of the terminal device 180. An entity “victim name: Company N, damage amount: 10 billion yen, attack technique: phishing attack” extracted from the report is displayed on the screen of the terminal device 180. In extraction of a general entity, “Company A” may be erroneously determined as a victim name. According to the present example embodiment, it is possible to prevent an occurrence of a situation in which “Company A” is erroneously determined as the victim name, by using the relevant information (meaning) of the entity candidate extracted from the report. Therefore, according to the present example embodiment, the entity included in the report is accurately identified. The user can accurately understand the entity included in the report by viewing information displayed on the screen of the terminal device 180.

### Operation

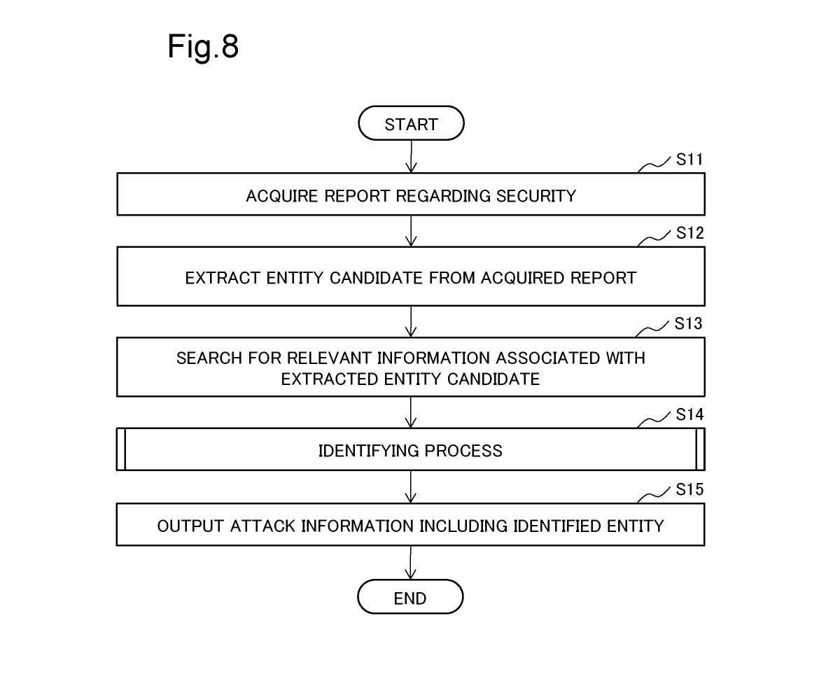

Next, an example of an operation of the information presentation device in the present disclosure will be described with reference to the drawings. FIG. 8 is a flowchart illustrating the example of the operation of the information presentation device in the present disclosure. In the description of processing as per the flowchart in FIG. 8, a component of the information presentation device 10 is assumed as an operating subject. The operating subject of the processing as per the flowchart in FIG. 8 may be the information presentation device 10. For example, the processing as per the flowchart in FIG. 8 is achieved by a processor executing a program stored in a memory mounted in a computer (not illustrated) in which the information presentation device 10 is implemented.

In FIG. 8, first, the acquisition unit 11 acquires a report regarding security (Step S11).

Then, the extraction unit 12 extracts an entity candidate from the acquired report (Step S12).

Then, the search unit 14 searches for relevant information associated with the extracted entity candidate (Step S13). For example, the search unit 14 is configured to search for relevant information from a dedicated database built for extracting an entity. For example, the search unit 14 may be configured to search for the relevant information via the Internet.

Then, the instruction unit 15 executes an identifying process (Step S14). The details of the identifying process in Step S14 will be described later.

Then, the output unit 17 outputs attack information including the identified entity (Step S15). The attack information output from the information presentation device 10 is displayed on the screen of the terminal device 180 used by the user.

### Identifying Process

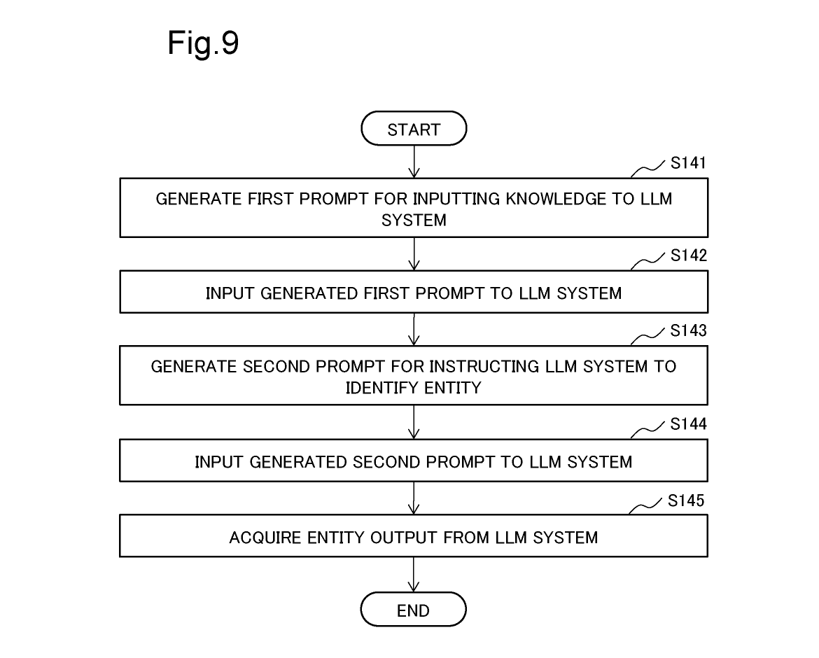

Next, an example of the identifying process (Step S14 in FIG. 8) by the information presentation device in the present disclosure will be described with reference to the drawings. FIG. 9 is a flowchart illustrating the example of the identifying process by the information presentation device in the present disclosure. In the description of the process as per the flowchart in FIG. 9, a component (instruction unit 15) of the information presentation device 10 is assumed as an operating subject. The operating subject of the process as per the flowchart in FIG. 9 may be the information presentation device 10.

In FIG. 9, first, the instruction unit 15 generates a first prompt for inputting knowledge to the LLM system 150 (Step S141).

Then, the instruction unit 15 inputs the generated first prompt to the LLM system 150 (Step S142). The instruction unit 15 acquires text information output from the LLM system 150 in response to an input of the first prompt.

Then, the instruction unit 15 generates a second prompt for instructing the LLM system to identify an entity (Step S143).

Then, the instruction unit 15 inputs the generated second prompt to the LLM system 150 (Step S144).

Then, the instruction unit 15 acquires an entity output from the LLM system 150 (Step S145). After Step S145, the process proceeds to Step S15 in the flowchart in FIG. 8.

### Modifications

Next, a modification of the present example embodiment will be described with reference to the drawings. The following modifications are examples of processing by the information presentation device in the present example embodiment, and do not limit processing by the information presentation device in the present example embodiment.

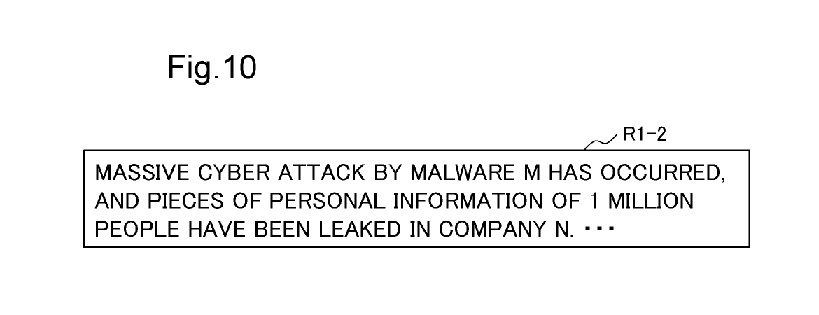

FIGS. 10 to 14 are conceptual diagrams relating to the present modification. The present modification is an example in which a report and an entity are different.

FIG. 10 is a conceptual diagram illustrating an example of a report regarding a security attack, which is acquired by an information presentation device in the present disclosure. A report R1-2 includes contents related to security, that “massive cyber attack by Malware M has occurred, and pieces of personal information of 1 million people have been leaked in Company N....” Entity candidates “Malware M” and “Company N” are extracted from the report R1-2.

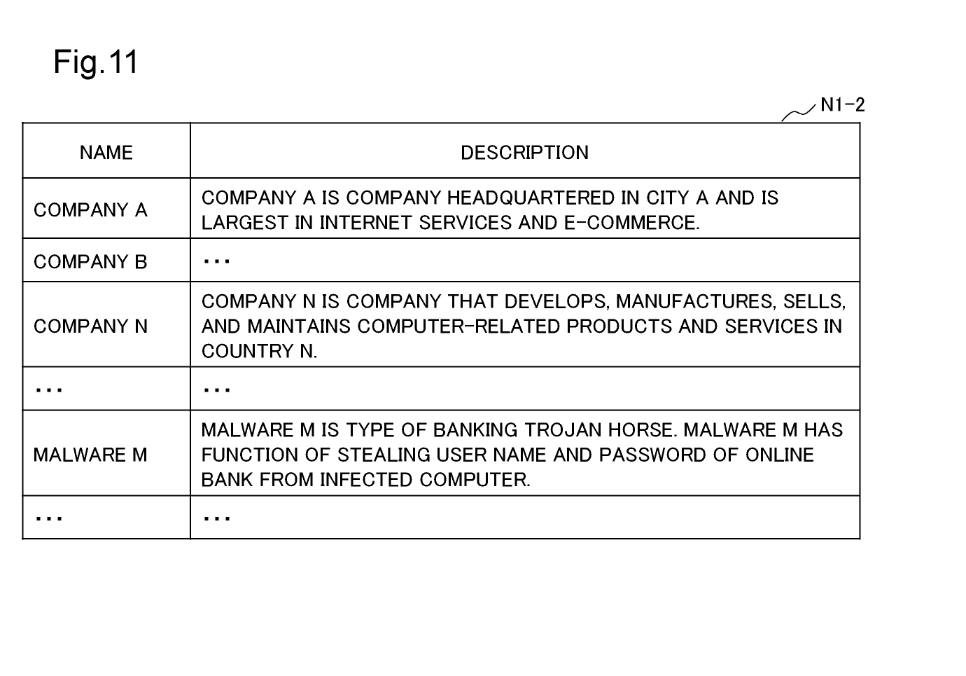

FIG. 11 is a table showing an example of knowledge searched for by the information presentation device in the present disclosure. A knowledge table N1-2 stores a name indicating an entity candidate and a description (knowledge) regarding the entity candidate. The name indicating the entity candidate is associated with knowledge about the entity candidate. For example, with respect to “Company N”, knowledge that “Company N is a company that develops, manufactures, sells, and maintains computer-related products and services in Country N.” is associated. For example, with respect to “Malware M”, knowledge that “malware M is a type of banking Trojan horse. The malware M has a function of stealing a user name and a password of an online bank from an infected computer.” is associated.

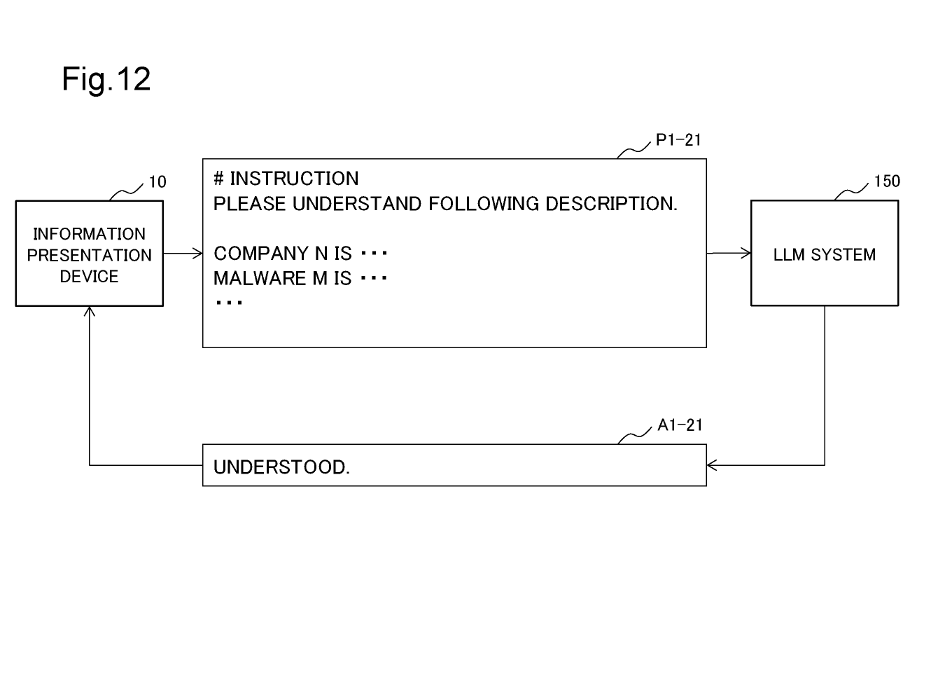

FIG. 12 is a conceptual diagram illustrating an example of the prompt generated by the information presentation device in the present disclosure. FIG. 12 illustrates an example of a first prompt P1-21 generated by the information presentation device 10. The first prompt P1-21 includes an instruction sentence, and knowledge for each entity candidate. The instruction sentence includes text information indicating that “please understand the following description”. The knowledge for each entity candidate includes a description exemplified in the knowledge table N1-2 of FIG. 11. FIG. 12 illustrates an answer A1-21 output from the LLM system 150 in response to an input of the first prompt P1-21. The answer A1-21 includes text information indicating that contents of the first prompt P1-21 are input as a precondition to the LLM system 150, that is, “understood”.

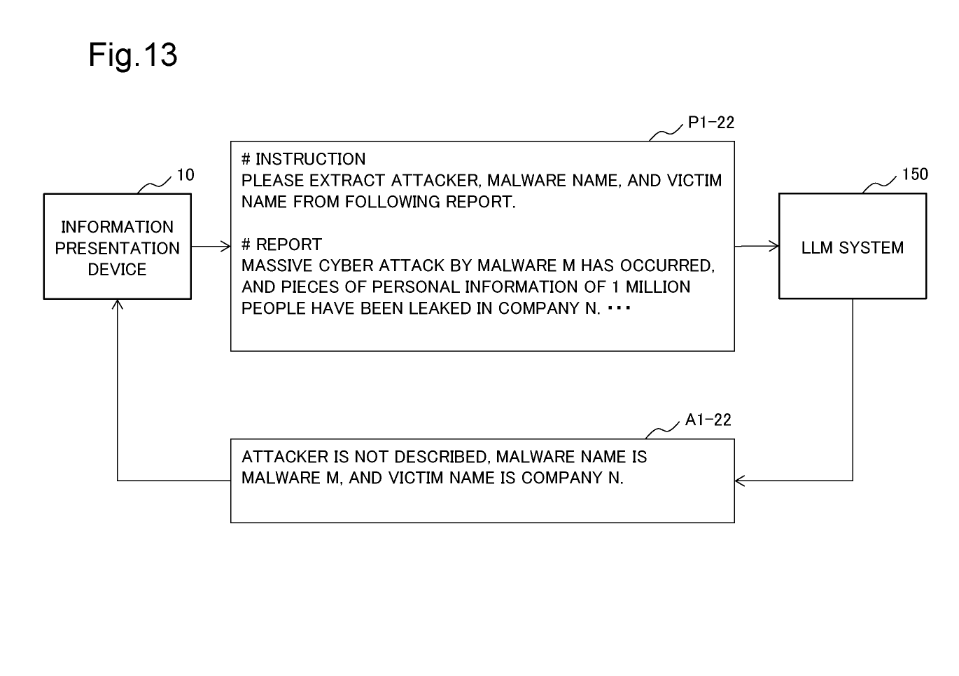

FIG. 13 is a conceptual diagram illustrating an example of the prompt generated by the information presentation device in the present disclosure. FIG. 13 illustrates an example of a second prompt P1-22 generated by the information presentation device 10. The second prompt P1-22 includes an instruction sentence and the body of the report. The instruction sentence includes text information indicating that “please extract an attacker, a malware name, and a victim name from the following report”. The body of the report includes the body of the report R1-2 illustrated in FIG. 10. FIG. 13 illustrates an answer A1-22 output from the LLM system 150 in response to an input of the second prompt P1-22. The answer A1-22 includes text information indicating that “the attacker is not described, the malware name is Malware M, and the victim name is Company N”. The answer A1-22 includes an entity extracted based on the knowledge input by the first prompt P1-21.

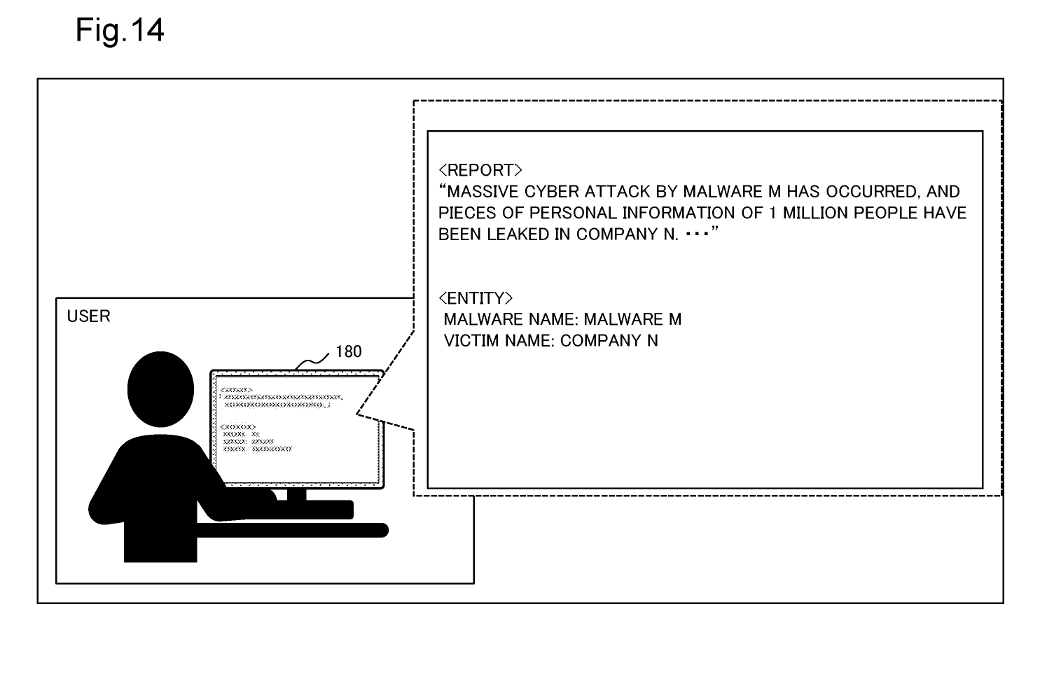

FIG. 14 is a conceptual diagram illustrating a display example of an entity output from the information presentation device in the present disclosure. Text information indicating a body of a report that “massive cyber attack by Malware M has occurred, and pieces of personal information of 1 million people have been leaked in Company N....” is displayed on the screen of the terminal device 180. An entity “malware name: Malware M, victim name: Company N” extracted from the report is displayed on the screen of the terminal device 180. The user can accurately understand the entity included in the report by viewing information displayed on the screen of the terminal device 180.

As described above, the information presentation device in the present example embodiment includes the acquisition unit, the extraction unit, the search unit, the identifying unit, the instruction unit, and the output unit. The acquisition unit acquires a report (document data) regarding cybersecurity. The extraction unit extracts a candidate for an entity related to the cybersecurity from the acquired document data. The search unit searches for relevant information associated with the extracted candidate. The search unit searches for the relevant information associated with the candidate by referring to a table in which relevant information is associated with each entity. The instruction unit (generation unit) generates an instruction (prompt) to request identification of an entity related to security, which is included in the document data, by using the document data and the relevant information extracted for each candidate. The instruction unit inputs the generated instruction to a model (large-scale language model). The identifying unit identifies an entity output from the model in response to the instruction. The output unit outputs attack information including the identified entity.

In the present example embodiment, an entity included in document data regarding cybersecurity is identified based on relevant information associated with an entity candidate extracted from the document data. Therefore, according to the present example embodiment, it is possible to accurately present an entity included in a document regarding cybersecurity.

In an aspect of the present example embodiment, the extraction unit extracts, from the document data, candidates for an entity related to an attacker, an attack, a vulnerability, a victim, and an attack target. In the present example embodiment, an entity included in document data is identified based on relevant information associated with the candidate for an entity related to an attacker, an attack, a vulnerability, a victim, and an attack target. According to the present example embodiment, it is possible to accurately present entities related to an attacker, an attack, a vulnerability, a victim, and an attack target.

In an aspect of the present example embodiment, the generation unit generates an instruction to extract an entity for each type of the entity. According to the present aspect, by extracting the entity for each type of entity, it is possible to more accurately identify an entity included in document data.

In an aspect of the present example embodiment, the search unit searches for relevant information associated with the candidate by referring to disclosed external data. According to the present aspect, even though the table in which relevant information for each entity is collected is not prepared in advance, it is possible to search for relevant information associated with a candidate for an entity included in document data.

In an aspect of the present example embodiment, the output unit displays information regarding an entity included in attack information on the screen of the terminal device used by the user. According to the present aspect, it is possible to accurately understand the entity included in the report by viewing information displayed on the screen of the terminal device.

### Second Example Embodiment

Next, an information presentation device according to a second example embodiment will be described with reference to the drawings. The information presentation device in the present example embodiment is different from the information presentation device in the first example embodiment in that information (knowledge graph) indicating a relationship between entities is used as knowledge instead of the description of an entity.

The information presentation device in the present example embodiment is connected to a terminal device and an LLM system similar to those in the first example embodiment via a network such as the Internet or an intranet. In the present example embodiment, details of the terminal device and the LLM system will not be described. In the present example embodiment, contents overlapping with those of the first example embodiment will be described in a simplified manner.

### Configuration

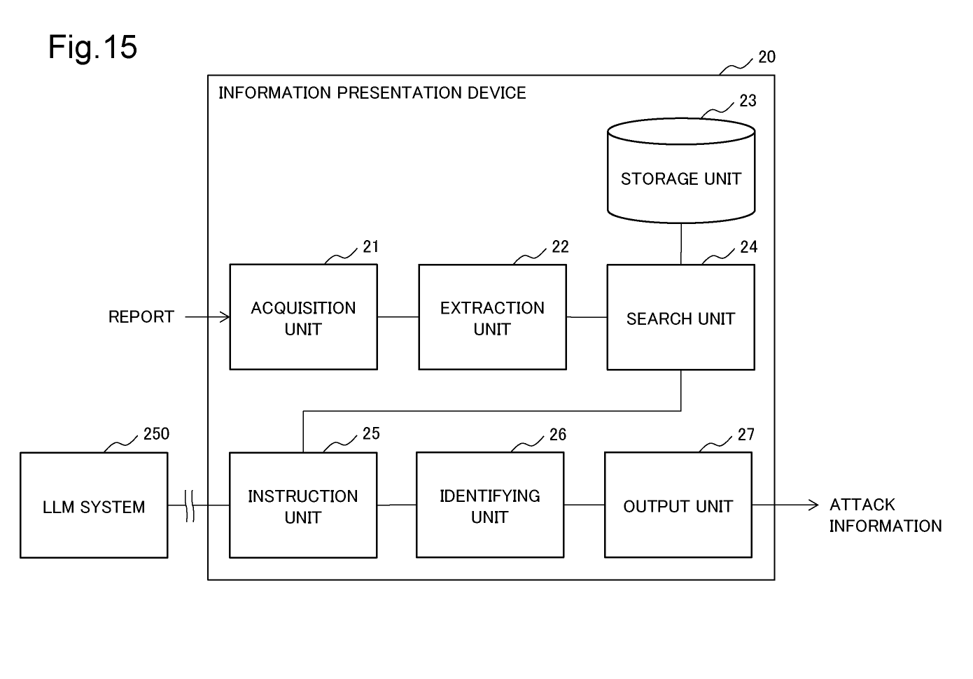

FIG. 15 is a block diagram illustrating an example of a configuration of the information presentation device in the present disclosure. An information presentation device 20 includes an acquisition unit 21, an extraction unit 22, a storage unit 23, a search unit 24, an instruction unit 25, an identifying unit 26, and an output unit 27. The instruction unit 25 is connected to an LLM system 250.

The acquisition unit 21 has the similar configuration to the acquisition unit 11 in the first example embodiment. The acquisition unit 21 acquires a report regarding a security attack from an external Website or the like. For example, the report is a document regarding security, such as news regarding security, a threat report, or a damage report. The report is not limited to news, a threat report, a damage report, or the like as long as the report includes information regarding a security attack.

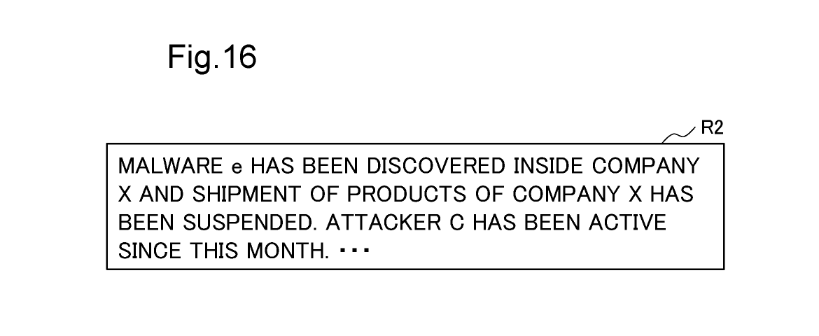

FIG. 16 is a conceptual diagram illustrating an example of a report regarding a security attack, which is acquired by the information presentation device in the present disclosure. A report R2 includes contents related to security, that “Malware e has been discovered inside Company X and shipment of products of Company X has been suspended. Attacker C has been active since this month....”.

The extraction unit 22 has the similar configuration to the extraction unit 12 in the first example embodiment. The extraction unit 22 extracts an entity candidate related to security from the acquired report. In the example of FIG. 16, entity candidates “Company X”, “Malware e”, and “Attacker C” are extracted from the report R2.

The storage unit 23 stores a knowledge graph including knowledge associated with a target related to security. The target related to security includes a victim name, a damage description, a damage amount, an attacker name, an attack technique name, an attack tool, an attack technique, malware, a campaign name, an exploited vulnerability, targeted software, and the like, which may be entities. The knowledge graph is stored in the storage unit 23 in advance. In a case where the knowledge graph disclosed via a network is searched, the storage unit 23 may be omitted.

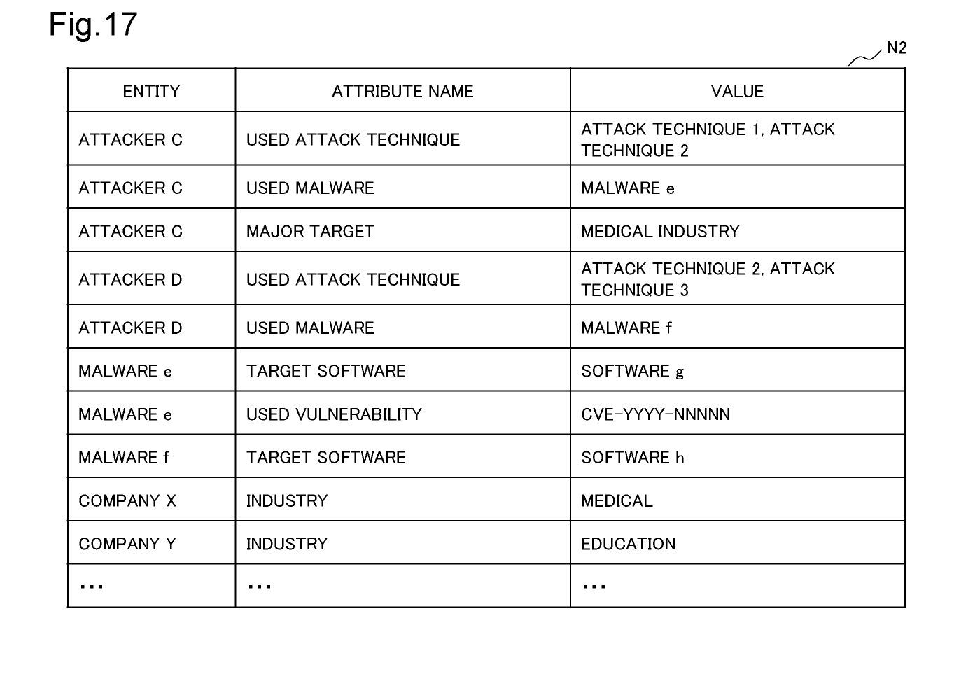

FIG. 17 is a table showing an example of knowledge searched for by the information presentation device in the present disclosure. A knowledge table N2 includes relevant information for each entity. The relevant information includes a name indicating an entity, and an attribute name and a value associated with the entity. For example, with respect to an entity “Attacker C”, attribute names of “used attack technique”, “used malware”, and “major target” are associated. For example, a value “Malware e” is associated with “used malware” of “Attacker C”. “Malware e” is also an entity. In this case, “Malware e” is relevant to a second entity related to a first entity “Attacker C”.

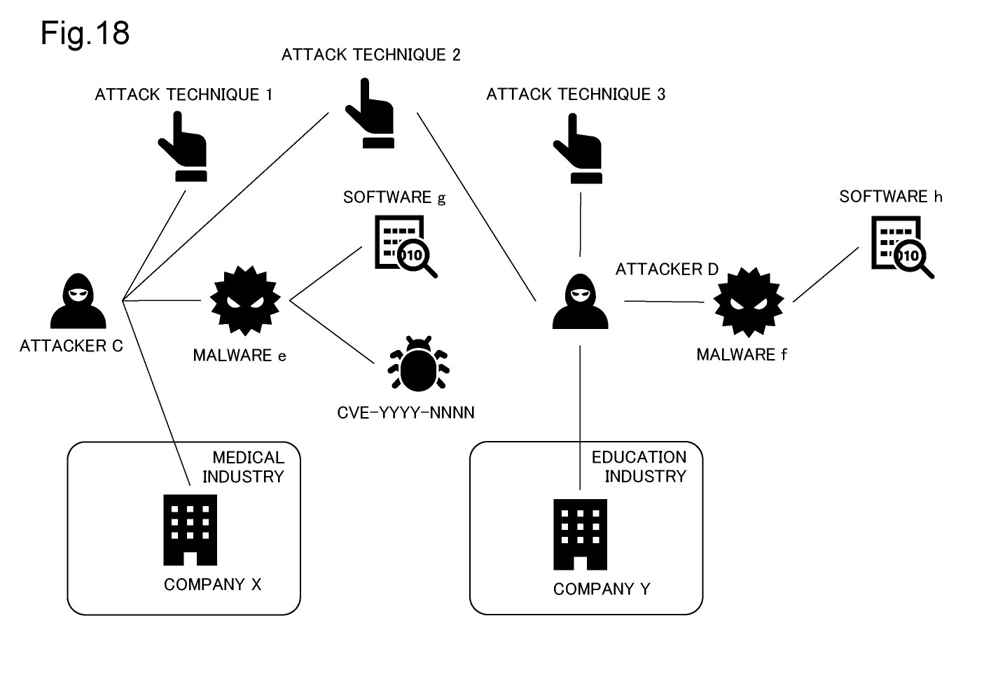

FIG. 18 is a conceptual diagram illustrating an example of the knowledge graph referred to by the information presentation device in the present disclosure. FIG. 18 illustrates a correlation relationship between entities included in the knowledge table N2 of FIG. 17. For example, an attacker C is associated with values of an attack technique 1, an attack technique 2, malware e, and a company X (medical industry). The malware e is also an entity. The entity of the malware e is associated with values of “Software g” and “CVE-YYYY-NNNN”. “Attack technique 2” is associated with an entity “Attacker D”. As described above, a plurality of entities have a correlation relationship with each other.

The search unit 24 searches the storage unit 23 for knowledge relevant to a value associated with an entity candidate extracted from the extraction unit 22, by using the entity candidate as a key. In the present example embodiment, the search unit 24 refers to a knowledge graph which is information indicating a relationship between entities, as knowledge. The knowledge graph is stored in the storage unit 23 in advance. The search unit 24 extracts the second entity associated with the entity candidate as relevant information, from the knowledge graph. In a case where there is a third entity associated with the second entity extracted as the relevant information, the search unit 24 may extract the third entity as the relevant information. As described above, the search unit 24 may be configured to extract relevant information in a chained manner by using the knowledge graph. The search unit 24 may be configured to search for information associated with the entity candidate extracted by the extraction unit 22, via a network. For example, the search unit 24 may be configured to refer to a disclosed knowledge graph by using a search engine available via a network.

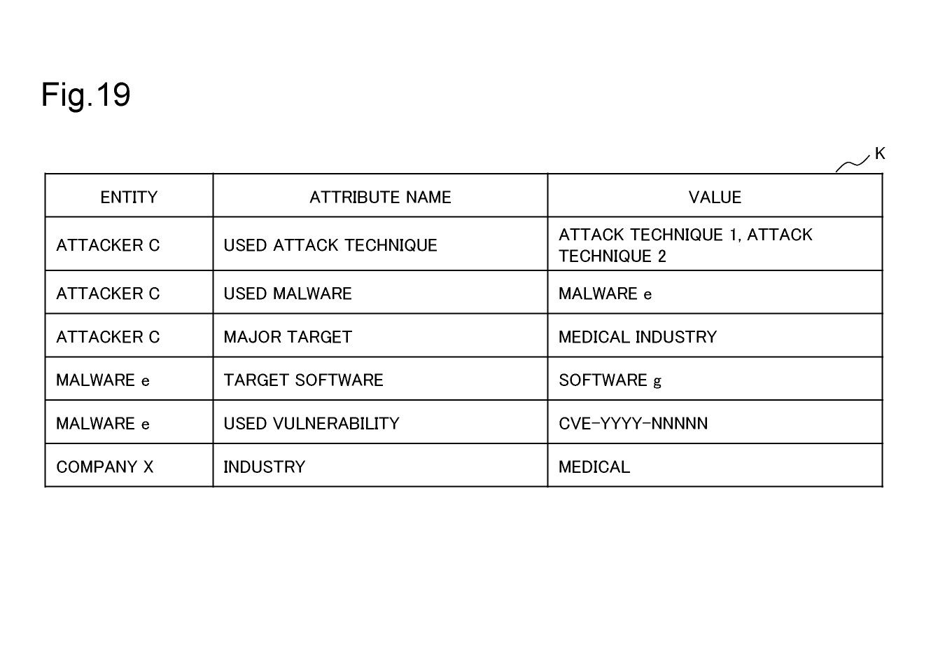

FIG. 19 is a conceptual diagram illustrating an example of relevant information searched for by the information presentation device in the present disclosure. Relevant information K includes an attribute name and a value associated with the entity candidates extracted from the report R2 of FIG. 16. Entity candidates of “Attacker C”, “Malware e”, and “Company X” are extracted from the report R2. The relevant information K is associated with relevant information for each of entity candidates of “Attacker C”, “Malware e”, and “Company X”.

The instruction unit 25 acquires a body (document data) of the acquired report. The instruction unit 25 acquires relevant information associated with the entity candidate extracted from the report. The instruction unit 25 generates a prompt (also referred to as an instruction) for identifying an entity related to security by using the relevant information associated with the entity candidate extracted from the report and the body of the report. A functional configuration of the instruction unit 25 for generating the prompt (instruction) is also referred to as a generation unit. The instruction unit 25 inputs the generated prompt into the LLM system 250. In the present example embodiment, the instruction unit 25 generates a first prompt and a second prompt. The instruction unit 25 may handle a title, an appendix, or a summary of the report as document data instead of the body of the acquired report. Alternatively, the instruction unit 25 may handle at least any combination of the body, the title, the appendix, and the summary of the report as the document data.

The instruction unit 25 generates a first prompt for inputting relevant information associated with the entity candidate to the LLM system 250. The first prompt includes relevant information for each entity candidate. The instruction unit 25 generates a first prompt by using a template set in advance. A template for generating the first prompt includes an instruction sentence that instructs to input relevant information associated with the entity candidate as a precondition. The instruction unit 25 may document relevant information by using a template set in advance, and generate the first prompt including the documented relevant information. The instruction unit 25 inputs the generated first prompt into the LLM system 250.

The instruction unit 25 acquires text information output from the LLM system 250 in response to an input of the first prompt. The text information output from the LLM system 250 in response to the input of the first prompt is relevant to an answer to the first prompt. An answer to the first prompt triggers the information presentation device 20 to input a second prompt to the LLM system 250.

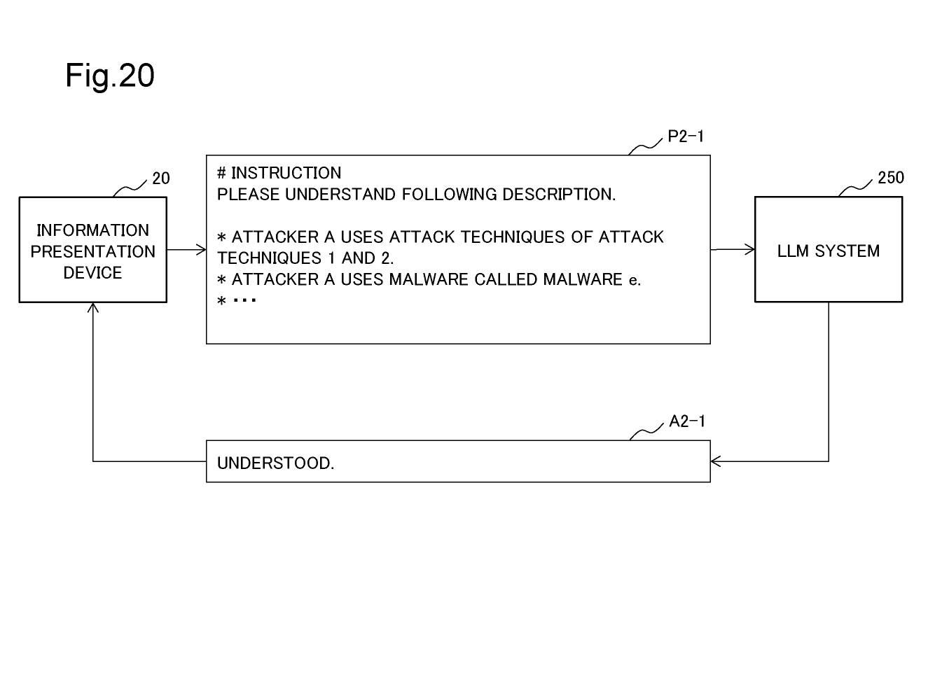

FIG. 20 is a conceptual diagram illustrating an example of the prompt generated by the information presentation device in the present disclosure. FIG. 20 illustrates an example of a first prompt P2-1 generated by the information presentation device 20. The first prompt P2-1 includes an instruction sentence, and relevant information for each entity candidate. The instruction sentence includes text information indicating that “please understand the following description”. The relevant information for each entity candidate includes the relevant information K illustrated in FIG. 19. FIG. 20 illustrates an answer A2-1 output from the LLM system 250 in response to an input of the first prompt P2-1. The answer A2-1 includes text information indicating that contents of the first prompt P2-1 are input as a precondition to the LLM system 250, that is, “understood”.

The instruction unit 25 also generates a second prompt to instruct the LLM system 250 to extract an entity from the body of the report. The second prompt includes an instruction to extract an entity from the body of the report. The second prompt may include an instruction to extract an entity from a title, an appendix, or a summary of the report, instead of the body of the report. The second prompt may include an instruction to extract an entity from at least any combination of the body, the title, the appendix, and the summary of the report. The instruction unit 25 generates the second prompt by using a template set in advance. The instruction unit 25 inputs the generated second prompt into the LLM system 250. The instruction unit 25 may be configured to generate a prompt in which the contents of the first prompt and the contents of the second prompt are unified. In that case, the prompt includes an instruction to input knowledge for each entity candidate as a precondition and an instruction to extract an entity from the body of the report.

The instruction unit 25 acquires text information output from the LLM system 250 in response to an input of the second prompt. The text information output from the LLM system 250 in response to the input of the second prompt is relevant to an answer to the second prompt. The text information includes an entity extracted from the report.

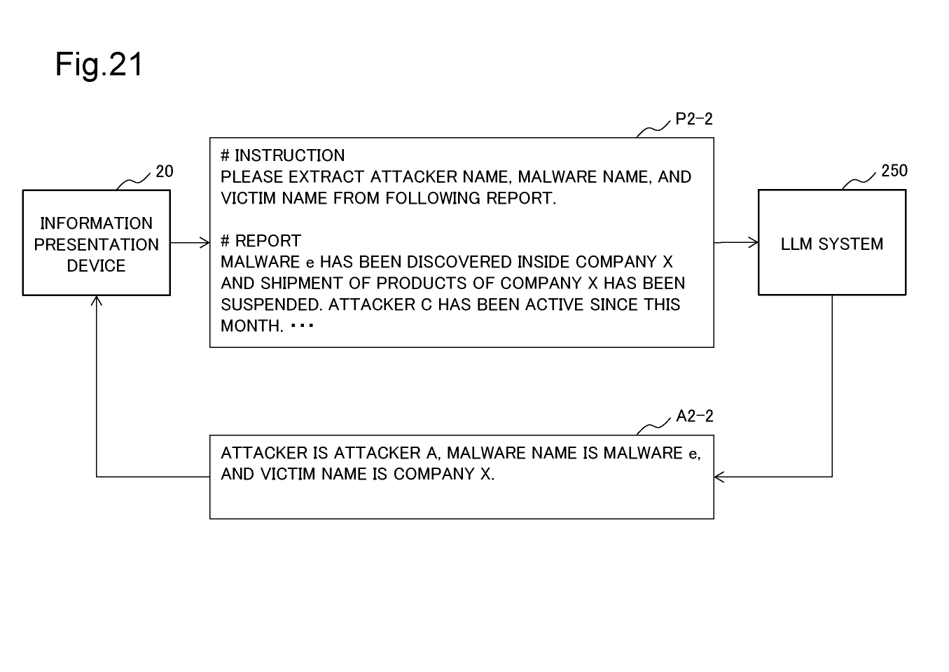

FIG. 21 is a conceptual diagram illustrating an example of the prompt generated by the information presentation device in the present disclosure. FIG. 21 illustrates an example of a second prompt P2-2 generated by the information presentation device 20. The second prompt P2-2 includes an instruction sentence and the body of the report. The instruction sentence includes text information indicating that “please extract an attacker name, a malware name, and a victim name from the following report”. The body of the report includes the body of the report R2 illustrated in FIG. 16. FIG. 21 illustrates an answer A2-2 output from the LLM system 250 in response to an input of the second prompt P2-2. The answer A2-2 includes text information indicating that “the attacker is Attacker A, the malware name is Malware e, and the victim name is Company X”. The answer A2-2 includes an entity extracted based on the relevant information input by the first prompt P2-1.

In the above description, the instruction unit 25 inputs information to the LLM system 250 by using the first prompt and the second prompt and acquires an entity included in the body of the report, and the present example embodiment is not limited to this. For example, the instruction unit 25 may input information to the LLM system 250 by using retrieval-augmented generation (RAG) or fine tuning instead of the first prompt in the above description. For example, the instruction unit 25 may generate a single prompt including both information included in the first prompt and information included in the second prompt. In that case, the instruction unit 25 inputs this single prompt to the LLM system 250, and acquires text information regarding an entity output from the LLM system 250.

The identifying unit 26 has the similar configuration to the identifying unit 16 in the first example embodiment. The identifying unit 26 acquires text information including an entity extracted from the report. The identifying unit 26 identifies an entity included in the text information. A configuration in which the text information including the entity extracted from the report is output to the output unit 27 may be made. In that case, the identifying unit 26 may be omitted.

The output unit 27 is connected to a terminal device 280 used by the user. The output unit 27 acquires the entity extracted from the body of the report. The output unit 27 outputs attack information (attack data) including the acquired entity to the terminal device 280. An entity included in the attack information output to the terminal device 280 is displayed on the screen of the terminal device 280. The output unit 27 may be configured to retain attack information including the entity in a database (not illustrated).

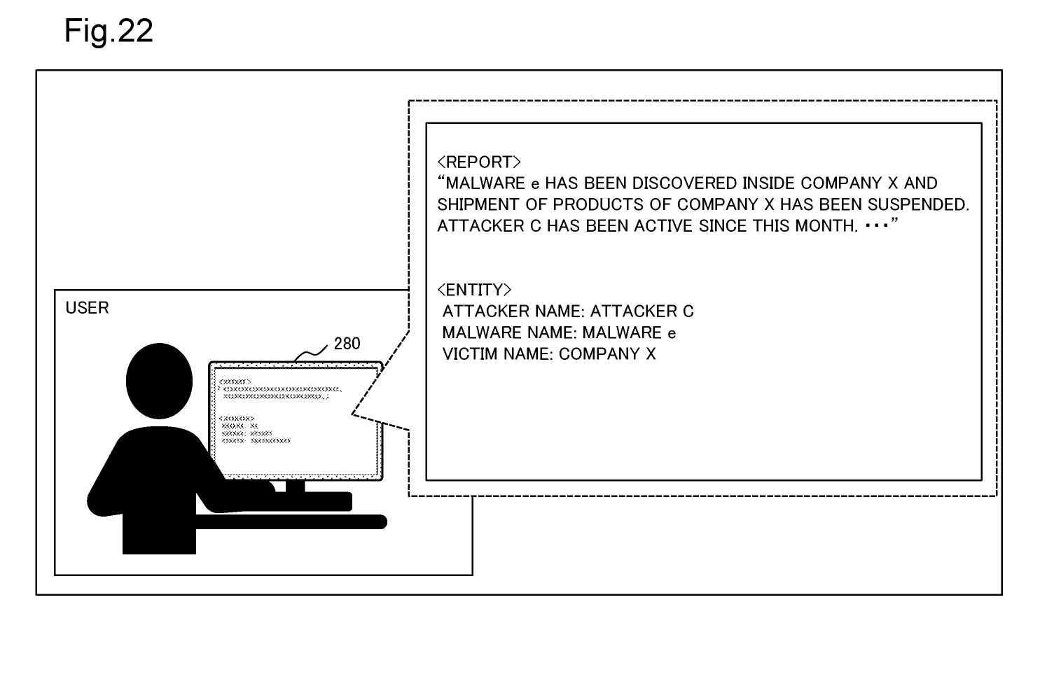

FIG. 22 is a conceptual diagram illustrating a display example of an entity output from the information presentation device in the present disclosure. Text information indicating a body of a report that Malware e has been discovered inside Company X and shipment of products of Company X has been suspended. Attacker C has been active since this month....” is displayed on the screen of the terminal device 280. An entity “attacker name: Attacker C, malware name: Malware e, victim name: company X” extracted from the report is displayed on the screen of the terminal device 280. In extraction of a general entity, the malware M may be erroneously determined as an attacker name. According to the present example embodiment, it is possible to prevent an occurrence of a situation in which the malware M is erroneously determined as the attacker name, by using the relevant information (meaning) of the entity candidate extracted from the report. Therefore, according to the present example embodiment, the entity included in the report is accurately identified. The user can accurately understand the entity included in the report by viewing information displayed on the screen of the terminal device 280.

### Operation

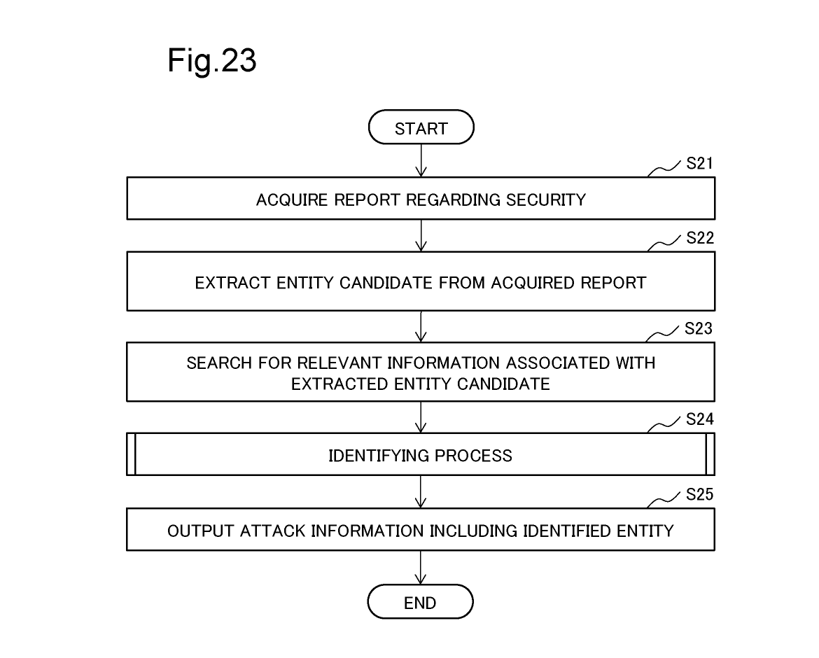

Next, an example of an operation of the information presentation device in the present disclosure will be described with reference to the drawings. FIG. 23 is a flowchart illustrating the example of the operation of the information presentation device in the present disclosure. In the description of processing as per the flowchart in FIG. 23, a component of the information presentation device 20 is assumed as an operating subject. The operating subject of the processing as per the flowchart in FIG. 23 may be the information presentation device 20. For example, the processing as per the flowchart in FIG. 23 is achieved by a processor executing a program stored in a memory mounted in a computer (not illustrated) in which the information presentation device 20 is implemented.

In FIG. 23, first, the acquisition unit 21 acquires a report regarding security (Step S21).

Then, the extraction unit 22 extracts an entity candidate from the acquired report (Step S22).

Then, the search unit 24 searches for relevant information associated with the extracted entity candidate (Step S23). For example, the search unit 24 is configured to search for relevant information from a dedicated database built for extracting an entity. For example, the search unit 24 may be configured to search for the relevant information via the Internet.

Then, the instruction unit 25 executes an identifying process (Step S24). The details of the identifying process in Step S24 will be described later.

Then, the output unit 27 outputs attack information including the identified entity (Step S25). The attack information output from the information presentation device 20 is displayed on the screen of the terminal device 280 used by the user.

### Identifying Process

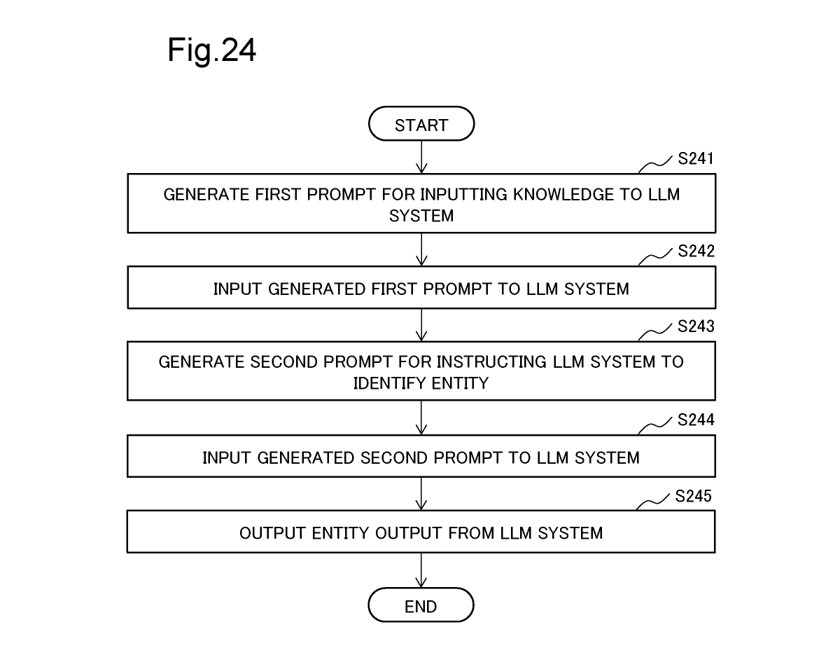

Next, an example of the identifying process (Step S24 in FIG. 23) by the information presentation device in the present disclosure will be described with reference to the drawings. FIG. 24 is a flowchart illustrating the example of the identifying process by the information presentation device in the present disclosure. In the description of the process as per the flowchart in FIG. 24, a component (instruction unit 25) of the information presentation device 20 is assumed as an operating subject. The operating subject of the process as per the flowchart in FIG. 24 may be the information presentation device 20.

In FIG. 24, first, the instruction unit 25 generates a first prompt for inputting knowledge to the LLM system 250 (Step S241).

Then, the instruction unit 25 inputs the generated first prompt into the LLM system 250 (Step S242). The instruction unit 25 acquires text information output from the LLM system 250 in response to an input of the first prompt.

Then, the instruction unit 25 generates a second prompt for instructing the LLM system to identify an entity (Step S243).

Then, the instruction unit 25 inputs the generated second prompt into the LLM system 250 (Step S244).

Then, the instruction unit 25 acquires an entity output from the LLM system 250 (Step S245). After Step S245, the process proceeds to Step S25 in the flowchart in FIG. 23.

As described above, the information presentation device in the present example embodiment includes the acquisition unit, the extraction unit, the search unit, the identifying unit, the instruction unit, and the output unit. The acquisition unit acquires a report (document data) regarding cybersecurity. The extraction unit extracts a candidate for an entity related to the cybersecurity from the acquired document data. The search unit searches for relevant information associated with the extracted candidate. The search unit searches for relevant information associated with the candidate by referring to a knowledge graph indicating a relationship between a plurality of entities. The instruction unit (generation unit) generates an instruction for identifying an entity related to security, which is included in document data, by using the document data and the relevant information extracted from the knowledge graph. The instruction unit inputs the generated instruction to a model (large-scale language model). The identifying unit identifies an entity output from the model in response to the instruction. The output unit outputs attack information including the identified entity.

In the present example embodiment, relevant information associated with the candidate is searched for by referring to a knowledge graph indicating a relationship between a plurality of entities. Therefore, according to the present example embodiment, it is possible to accurately identify an entity included in document data by referring to the knowledge graph.

In an aspect of the present example embodiment, the search unit searches for relevant information associated with an entity included in relevant information associated with the candidate, by referring to the knowledge graph. According to the present aspect, by extracting an entity included in document data in a chained manner, it is possible to more accurately identify the entity included in the document data.

### Third Example Embodiment

Next, an information presentation device according to a third example embodiment will be described with reference to the drawings. The information presentation device in the present example embodiment has a configuration in which the information presentation device in the first and second example embodiments is simplified. For example, functions of components included in the information presentation device in the present example embodiment are achieved by the functions of the components included in the information presentation device according to the first and second example embodiments.

### Configuration

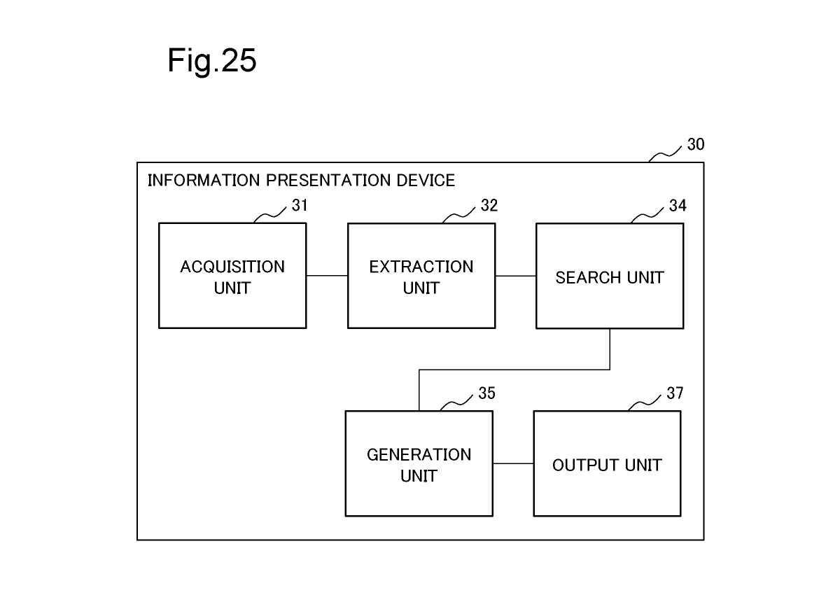

FIG. 25 is a block diagram illustrating an example of a configuration of the information presentation device in the present disclosure. An information presentation device 30 includes an acquisition unit 31, an extraction unit 32, a search unit 34, a generation unit 35, and an output unit 37.

The acquisition unit 31 acquires document data regarding cybersecurity. The extraction unit 32 extracts a candidate for an entity related to the cybersecurity from the acquired document data. The search unit 34 searches for relevant information associated with the extracted candidate. The generation unit 35 generates an instruction to request identification of an entity related to security, which is included in the document data, by using the document data and the relevant information extracted for each candidate. The output unit 37 outputs attack information including an entity output from a model in response to the instruction.

### Operation

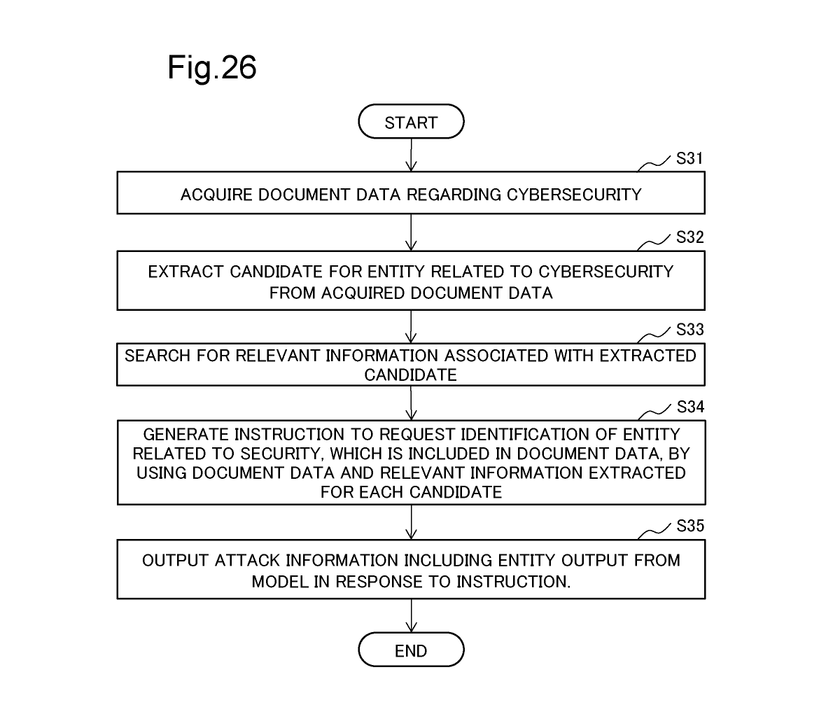

FIG. 26 is a flowchart illustrating an example of an operation of the information presentation device in the present disclosure. In the description of processing as per the flowchart in FIG. 26, a component of the information presentation device 30 is assumed as an operating subject. The operating subject of the processing as per the flowchart in FIG. 26 may be the information presentation device 30.

The acquisition unit 31 acquires document data regarding cybersecurity (Step S31).

The extraction unit 32 extracts a candidate for an entity related to the cybersecurity from the acquired document data (Step S32).

The search unit 34 searches for relevant information associated with the extracted candidate (Step S33).

The generation unit 35 generates an instruction to request identification of an entity related to security, which is included in the document data, by using the document data and the relevant information extracted for each candidate (Step S34).

The output unit 37 outputs attack information including an entity output from a model in response to the instruction (Step S35).

In the present example embodiment, an entity included in document data regarding cybersecurity is identified based on relevant information associated with an entity candidate extracted from the document data. Therefore, according to the present example embodiment, it is possible to accurately present an entity included in a document regarding cybersecurity.

### Hardware

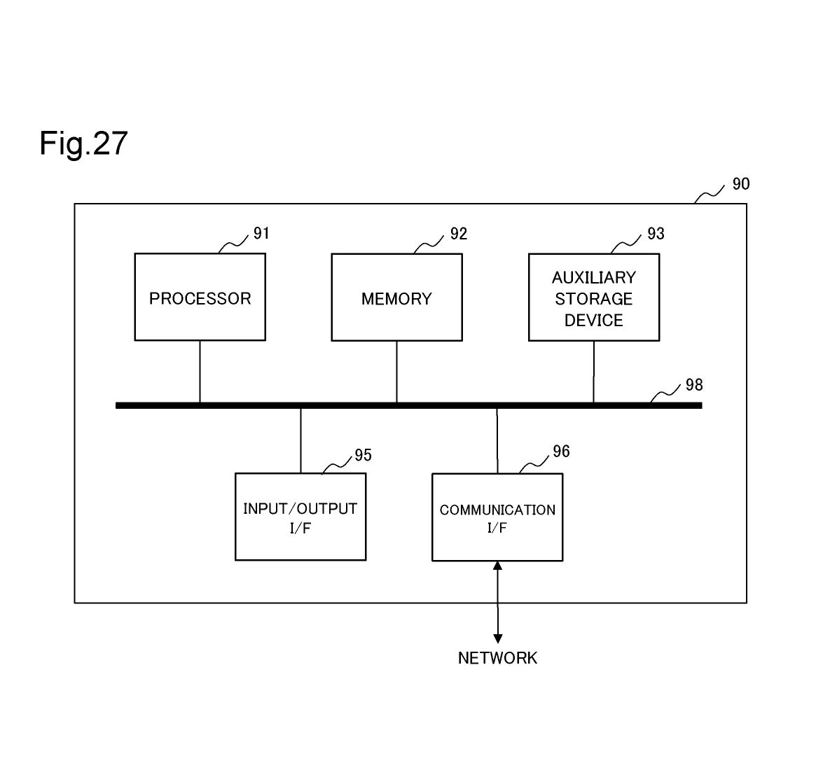

Next, a hardware configuration for executing processing in the present disclosure will be described with reference to the drawings. FIG. 27 is a block diagram illustrating an example of a hardware configuration that executes processing in the present disclosure. Here, an information processing device 90 (computer) is illustrated as an example of the hardware configuration. The information processing device in FIG. 27 has an exemplary configuration for executing processing in the present disclosure and does not limit the scope of the present disclosure.

As illustrated in FIG. 27, the information processing device 90 includes a processor 91, a memory 92, an auxiliary storage device 93, an input/output interface 95, and a communication interface 96. In FIG. 27, the interface is abbreviated as an I/F. The information processing device 90 may include a plurality of pieces of at least one of the processor 91, the memory 92, the auxiliary storage device 93, the input/output interface 95, and the communication interface 96. The processor 91, the memory 92, the auxiliary storage device 93, the input/output interface 95, and the communication interface 96 are connected to each other via a bus 98 in such a way that data communication is allowed. The processor 91, the memory 92, the auxiliary storage device 93, and the input/output interface 95 are connected to a network such as the Internet or an intranet via the communication interface 96.

The processor 91 loads a program (command) stored in the auxiliary storage device 93 or the like into the memory 92. For example, the program is a software program for executing processing in the present disclosure. The processor 91 executes the program loaded into the memory 92. The processor 91 executes processing in the present disclosure by executing the program. The processor 91 may be constituted by a single piece of hardware or may be constituted by a plurality of pieces of hardware.

The memory 92 is a storage device having an area into which a program is loaded. A program stored in the auxiliary storage device 93 or the like is loaded into the memory 92 by the processor 91. The memory 92 is achieved by, for example, a volatile memory such as a dynamic random access memory (DRAM). A nonvolatile memory such as a magnetoresistive random access memory (MRAM) may be applied as the memory 92. The memory 92 may be constituted by a single piece of hardware or may be constituted by a plurality of pieces of hardware.

The auxiliary storage device 93 stores various types of data such as programs. For example, the auxiliary storage device 93 is achieved by a local disk such as a hard disk or a flash memory. The auxiliary storage device 93 may be constituted by a single piece of hardware or may be constituted by a plurality of pieces of hardware. The auxiliary storage device 93 may be configured as external hardware. The memory 92 may be formed to store various types of data in such a way that the auxiliary storage device 93 can be omitted.

The input/output interface 95 is an interface for connecting the information processing device 90 and peripheral equipment in accordance with a standard or a specification. The communication interface 96 is an interface for connecting to an external system or device through a network such as the Internet or an intranet in accordance with a standard or a specification. The input/output interface 95 may be constituted by a single piece of hardware or may be constituted by a plurality of pieces of hardware. The input/output interface 95 and the communication interface 96 may be merged as an interface connected to external equipment.

Input equipment such as a keyboard, a mouse, and a touch panel may be connected to the information processing device 90, as necessary. These sorts of input equipment are used to input information and settings. In a case where the touch panel is used as the input equipment, a screen having a touch panel function serves as an interface. The processor 91 and the input equipment are connected via the input/output interface 95.

The information processing device 90 may be provided with display equipment for displaying information. In a case where the display equipment is provided, the information processing device 90 includes a display control device (not illustrated) for controlling display on the display equipment. The information processing device 90 and the display equipment are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via the input/output interface 95.

The above is an example of the hardware configuration for enabling processing in the present disclosure. The hardware configuration in FIG. 27 is an example of the hardware configuration for executing processing in the present disclosure and does not limit the scope of the present disclosure. A program for causing a computer to execute processing in the present disclosure is also included in the scope of the present disclosure.

A program recording medium in which a program for executing processing in the present example embodiment is recorded is also included in the scope of the present invention. For example, the program recording medium is a non-transitory computer-readable recording medium. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. The recording medium may be achieved by a magnetic recording medium such as a flexible disk, or other recording media.

The components in the present disclosure may be combined in any manner. The components in the present disclosure may be achieved by software. The components in the present disclosure may be achieved by a circuit. The components in the present disclosure may be achieved by cloud computing.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments may be described as the following Supplementary Notes, but are not limited to the following Supplementary Notes. In the following Supplementary Notes, dependent items in each category may also depend on other categories. The description included in the following Supplementary Notes has significance as a basis for amendment.

### Supplementary Note 1

An information presentation device including:

an acquisition unit that acquires document data regarding cybersecurity;

an extraction unit that extracts a candidate for an entity related to the cybersecurity from the acquired document data;

a search unit that searches for relevant information associated with the extracted candidate;

a generation unit that generates an instruction to request identification of an entity related to security, which is included in the document data, by using the document data and the relevant information extracted for each of the candidates; and

an output unit that outputs attack information including an entity output from a model in response to the instruction.

### Supplementary Note 2

The information presentation device according to Supplementary Note 1, in which

the search unit searches for the relevant information associated with the candidate by referring to a table in which relevant information is associated with each entity.

### Supplementary Note 3

The information presentation device according to Supplementary Note 2, in which

the generation unit generates an instruction to extract the entity for each type of entity.

### Supplementary Note 4

The information presentation device according to Supplementary Note 1, in which

the search unit

searches for the relevant information associated with the candidate by referring to a knowledge graph indicating a relationship between a plurality of entities, and

the generation unit

generates an instruction for identifying the entity related to security, which is included in the document data, by using the document data and relevant information extracted from the knowledge graph.

### Supplementary Note 5

The information presentation device according to Supplementary Note 4, in which

the search unit searches for relevant information associated with an entity included in the relevant information associated with the candidate by referring to the knowledge graph.

### Supplementary Note 6

The information presentation device according to Supplementary Note 1, in which

the search unit searches for the relevant information associated with the candidate by referring to disclosed external data.

### Supplementary Note 7

The information presentation device according to Supplementary Note 1, in which

the extraction unit extracts, from the document data, a candidate for an entity related to at least one of an attacker, an attack, a vulnerability, a victim, and an attack target.

### Supplementary Note 8

The information presentation device according to any one of Supplementary Notes 1 to 7, in which

the output unit displays information regarding the entity included in the attack information on a screen of a terminal device used by a user.

### Supplementary Note 9

An information presentation method including:

by a computer,

acquiring document data regarding cybersecurity;

extracting a candidate for an entity related to the cybersecurity from the acquired document data;

searching for relevant information associated with the extracted candidate;

generating an instruction for identifying an entity related to security among the candidates by using the document data and relevant information extracted for each of the candidates; and

outputting attack information including an entity output from a model in response to the instruction.

### Supplementary Note 10

A program for causing a computer to execute a process including:

acquiring document data regarding cybersecurity;

extracting a candidate for an entity related to the cybersecurity from the acquired document data;

searching for relevant information associated with the extracted candidate;

generating an instruction for identifying an entity related to security among the candidates by using the document data and relevant information extracted for each of the candidates; and

outputting attack information including the entity output from a model in response to the instruction.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

1. An information presentation device comprising:
a memory storing instructions; and
a processor connected to the memory and configured to execute the instructions to:
acquire document data regarding cybersecurity;
extract a candidate for an entity related to the cybersecurity from the acquired document data;
searches for relevant information associated with the extracted candidate;
generate an instruction to request identification of an entity related to security, which is included in the document data, by using the document data and the relevant information extracted for each of the candidates; and
output attack information including an entity output from a model in response to the instruction.

2. The information presentation device according to claim 1, wherein
the processor is configured to execute the instructions to
search for the relevant information associated with the candidate by referring to a table in which relevant information is associated with each entity.

3. The information presentation device according to claim 2, wherein
the processor is configured to execute the instructions to
generate an instruction to extract the entity for each type of entity.

4. The information presentation device according to claim 1, wherein
the processor is configured to execute the instructions to
search for the relevant information associated with the candidate by referring to a knowledge graph indicating a relationship between a plurality of entities, and
generate an instruction for identifying the entity related to security, which is included in the document data, by using the document data and relevant information extracted from the knowledge graph.

5. The information presentation device according to claim 4, wherein
the processor is configured to execute the instructions to
search for relevant information associated with an entity included in the relevant information associated with the candidate by referring to the knowledge graph.

6. The information presentation device according to claim 1, wherein
the processor is configured to execute the instructions to
search for the relevant information associated with the candidate by referring to disclosed external data.

7. The information presentation device according to claim 1, wherein
the processor is configured to execute the instructions to
extract, from the document data, a candidate for an entity related to at least one of an attacker, an attack, a vulnerability, a victim, and an attack target.

8. The information presentation device according to claim 1, wherein
the processor is configured to execute the instructions to
display information regarding the entity included in the attack information on a screen of a terminal device used by a user.

9. An information presentation method comprising:
by a computer,
acquiring document data regarding cybersecurity;
extracting a candidate for an entity related to the cybersecurity from the acquired document data;
searching for relevant information associated with the extracted candidate;
generating an instruction for identifying an entity related to security among the candidates by using the document data and relevant information extracted for each of the candidates; and
outputting attack information including an entity output from a model in response to the instruction.

10. A recording medium storing a program for causing a computer to execute a process comprising:
acquiring document data regarding cybersecurity;
extracting a candidate for an entity related to the cybersecurity from the acquired document data;
searching for relevant information associated with the extracted candidate;
generating an instruction for identifying an entity related to security among the candidates by using the document data and relevant information extracted for each of the candidates; and
outputting attack information including the entity output from a model in response to the instruction.
